(19) United States
(12) Patent Application Publication
(10) Pub. No.: US 2012/0086789 A1
(43) Pub. Date: Apr. 12, 2012

(54) IMAGING SYSTEM FOR IMAGING A VISCOELASTIC MEDIUM

(75) Inventors: Khalid Shahzad, Shrub Oak, NY (US); Ajay Anand, Fishkill, NY (US); John Petruzzello, Carmel, NY (US); Shiwei Zhou, Yorktown Heights, NY (US); Jan Frederik Suijver, Eindhoven (NL)

(73) Assignee: KONINKLIJKE PHILIPS ELECTRONICS N.V., EINDHOVEN (NL)

(21) Appl. No.: 13/377,936

(22) PCT Filed: Jun. 15, 2010
(86) PCT No.: PCT/IB2010/052668

§ 371 Date: Dec. 13, 2011

Related U.S. Application Data
(60) Provisional application No. 61/218,520, filed on Jun. 19, 2009.

(51) Int. Cl. H04N 7/18

(52) U.S. Cl. 348/65; 348/77; 348/E07.085

(57) ABSTRACT

An imaging system for imaging a viscoelastic medium is disclosed. The imaging system comprises a variable refractive lens (4) and a transducer system (5) for generating acoustic radiation. The imaging system is operated to alternate between first and second operating modes. While the variable refractive lens is operated to alternate between a first configuration and a second configuration, the transducer is operated to alternate between generating acoustic radiation for displacing the viscoelastic medium and acoustic radiation for imaging the displacement of the viscoelastic medium. In embodiments the variable refractive lens is a fluid focus lens. Moreover, in embodiments, the imaging system is integrated with a catheter-based interaction modality, such as a tissue ablation modality.

### FIELD OF THE INVENTION

The present invention relates to an imaging system for imaging a viscoelastic medium based on application of acoustic radiation.

### BACKGROUND OF THE INVENTION

Catheter-based surgery is advantageously used in various connections to treat body organs with minimal incision size and clearance of the organs. As an example, cardiac arrhythmias may be treated by various catheter-based ablation techniques to remove part of the cardiac tissue. Specifically, radio-frequency (RF) ablation, high intensity focused ultrasound (HIFU) or cryo-ablations of the tissue are commonly used.

Catheter-based surgery, nevertheless, suffers from certain drawbacks, one example being shortcomings in real-time assessment during the surgical procedure. For example in connection with catheter-based ablation, if the ablated tissue depth is too shallow then a relapse of the arrhythmias can take place and there may be a need for repeating the procedure, which can be very risky and costly. On the other hand, if the ablation depth is too deep, then there is a risk of cardiac perforation which could be fatal. To this end, ultrasound imaging based on tracking changes in the backscattered echo amplitude (B-mode) has been proposed as an ablation monitoring technique. Currently, however, there is no reliable way of monitoring the progression of an ablation procedure. The success of the procedure depends on the experience of the physician.

The published US patent application no. 2008/0276709 A1 discloses a method applicable in the field of medical imagining. It is disclosed to generate mechanical waves within a viscoelastic medium by use of an acoustic radiation force and to form a medical image based on a detection of the propagation of the waves within the medium

There is however still a need in the art for improved imaging equipment, suitable for use in connection with catheter-based surgery.

### SUMMARY OF THE INVENTION

It would be advantageous to achieve an imaging system which is suitable for real-time monitoring of a treatment process. It would also be desirable to provide an imaging system which is capable of real-time imaging of three-dimensional properties of treated tissue during the treatment process. Furthermore, it would also be desirable to provide an imaging system which is suitable for integration with a treatment modality, such as a probe-based treatment modality. In general, the invention preferably seeks to mitigate, alleviate or eliminate one or more disadvantages of the prior art, singly or in any combination.

To better address one or more of these concerns, in a first aspect of the invention an imaging system is presented that comprises:

a variable refractive lens;

a transducer system for generating acoustic radiation; the acoustic radiation being transmitted through the variable refractive lens;

wherein the imaging system is operated to:

in a first mode
arranging the variable refractive lens in a first configuration, and while the variable refractive lens is in the first configuration; operate the transducer system to generate acoustic radiation for displacing the viscoelastic medium; and

in a second mode
arranging the variable refractive lens in a second configuration, and while the variable refractive lens is in the second configuration; operate the transducer system to generate acoustic radiation for imaging the displacement of the viscoelastic medium.

The imaging system combines acoustic radiation force imaging (ARFI) with the application of a variable refractive lens which at least supports two configurations, one configuration suitable for use in connection with displacement of the viscoelastic medium, and one configuration suitable for use in connection with imaging of the displacement of the viscoelastic medium. This combination allows building both functionalities into a single device, making it compact.

A further advantage lies therein that the image system supports integration into a conventional catheter-based probe, thereby providing a very compact imaging device suitable for minimal incision surgery.

The imaging system may advantageously be used in connection with any type of imaging of viscoelastic media which undergo a change in elastic properties. In embodiments, the viscoelastic media is human or animal tissue, such as tissue under various types of surgery as well as tissue being monitored in connection with a lesion, where the lesion gives rise to a difference in elastic properties between the damaged tissue and the intact tissue, of particular interest in monitoring of cancerous lesions.

In an advantageous embodiment, the imaging system further comprises an interaction modality, e.g. a treatment modality, for modifying the viscoelastic medium, thereby providing an integrated treatment and imaging system. Such a device is of great benefit to the medical doctor performing the surgery in order to monitor in real-time the treatment progress. Advantageously, the interaction modality is an ablation modality, such as RF ablation, since ablation of a body organ changes the elastic properties of the organ. In-vivo ablation monitoring would be of great benefit to the medical doctor, e.g. to monitor the transmurality of the tissue during cardiac ablation to treat arrhythmia.

In advantageous embodiments, the variable refractive lens is a fluid lens, such as an electrowetting liquid lens. Fluid lenses can vary the lens shape, such that the first and second configurations can be provided by varying the lens shape.

In a second aspect of the invention, a computer program product is presented that is adapted to enable a computer system comprising at least one computer having data storage means associated therewith to control an imaging system according to the first aspect of the invention.

In a third aspect of the invention, a method of operating an imaging system is present. The method enables an imaging system to operate in accordance with the imaging system of the first aspect of the invention.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which:

FIG. 1 schematically illustrates the distal end of an RF ablation catheter-based probe;

FIG. 2 schematically illustrates an example of sequences of acoustic pulses emitted to image the elastic properties of the viscoelastic medium;

FIG. 3 schematically illustrates different configurations of a fluid focus lens assembly;

FIG. 4 schematically illustrates the operation of the fluid focus lens as used in connection with scanned imaging;

FIG. 5 illustrates an example of a displacement curve; and

FIG. 6 illustrates a flow chart of the operation of an image system.

### DESCRIPTION OF EMBODIMENTS

The present invention is disclosed in connection with a radio-frequency (RF) ablation catheter comprising an imaging system in accordance with embodiments of the present invention. It is however to be understood that, while such a configuration is advantageous, the invention is not limited to this. In fact, the imaging system may be applied in connection with any modality which alters the elastic properties of the viscoelastic medium under treatment. In particular, the imaging system may be used in connection with a catheter-based probe, such as a catheter-based ablation probe, e.g. RF ablation, high intensity focused ultrasound (HIFU) or cryo-ablations.

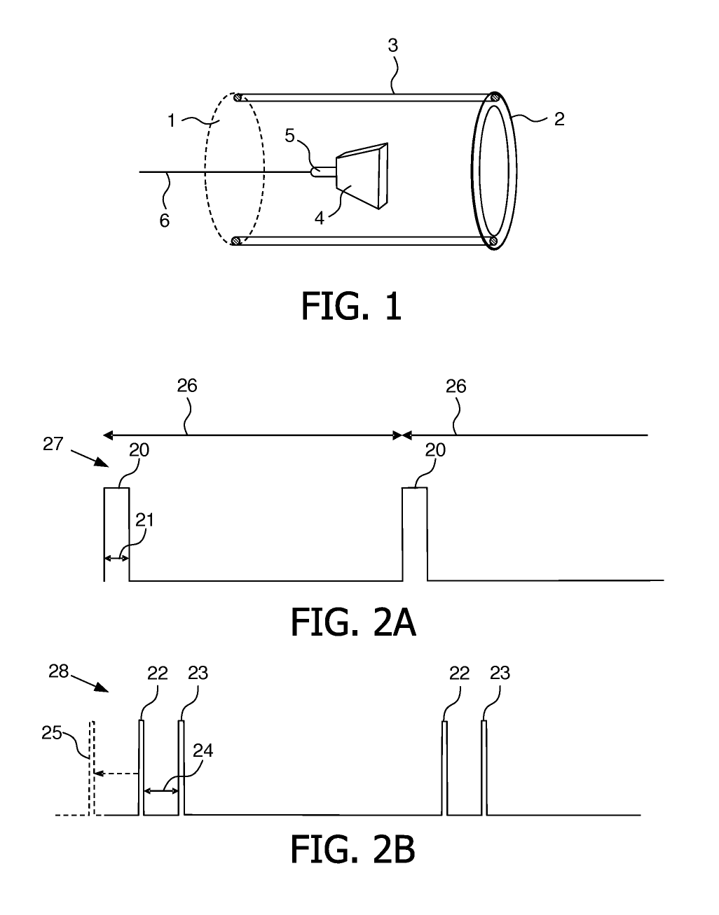

FIG. 1 schematically illustrates the distal end of an RF ablation catheter-based probe, hereafter simply referred to as a catheter. The Figure illustrates the catheter housing 1, the ablation ring 2 with feed wires 3, a variable refractive lens 4 in the form of a fluid focus lens assembly and an acoustic transducer 5 and control and feed connections 6 to the transducer 5 and the fluid lens 4. The catheter may at a proximal end (not shown) comprise a controller unit or connection for a controller unit, such as a dedicated purpose or general purpose computing unit.

The acoustic transducer 5 is operated to generate acoustic radiation. The transducer may be a single element transducer which can be operated both to emit acoustic radiation suitable for displacing the viscoelastic medium, as well as to emit acoustic radiation suitable for imaging the viscoelastic medium. The acoustic radiation is transmitted through and steered by the fluid focus lens 4. In an embodiment, the acoustic transducer is a piezo transducer for generating ultrasound. The piezo transducer may have a diameter of 1 to 2 mm operated at 30 Hz. Such a transducer may output up to 40 W/cm². In order to displace the tissue 10-100 micrometers, an output of 1-5 KW/cm² may be needed. By focusing the emitted radiation e.g. to an area of 50 micrometers, a transducer with the mentioned specifications may output up to 6 KW/cm². This is sufficient for displacing the tissue a desired amount. Generally, other transducer specifications are also applicable.

FIG. 2 schematically illustrates an example of sequences of acoustic pulses emitted to image the elastic properties of the viscoelastic medium, e.g. in the form of tissue.

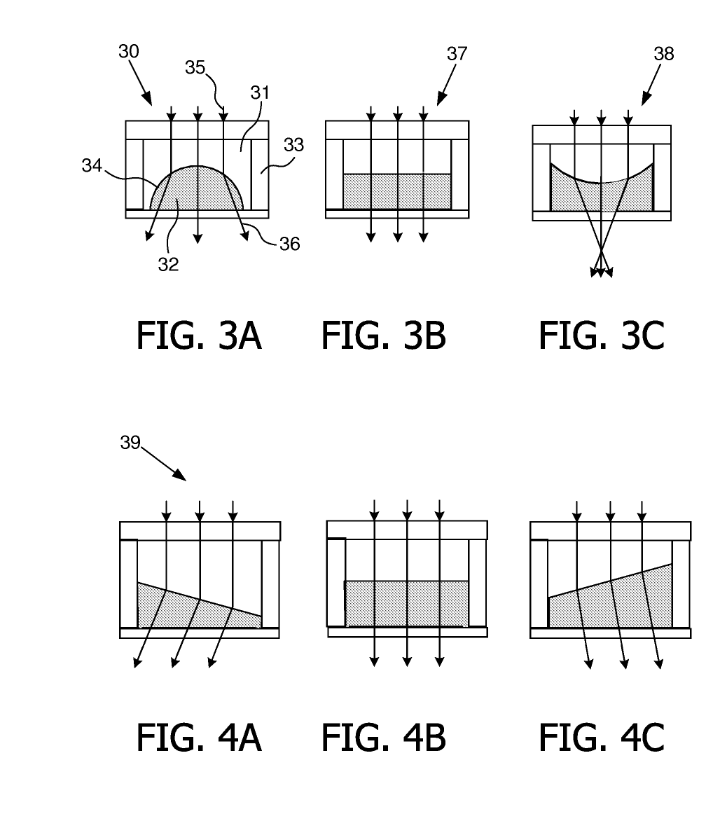

In a first mode, the fluid focus lens is arranged in a first or “push” configuration, this configuration is discussed in connection with FIG. 3. In the first mode, the transducer generates acoustic radiation for displacing or pushing the viscoelastic medium. An example of a push sequence is shown in FIG. 2A. The acoustic radiation 27 is in the form of pulses 20, also referred to as push pulses. A push pulse is a superposition of a large number of individual pulses, such as a few hundreds or even up to a few thousands pulses. The push pulse is build up of the acoustic radiation that is generated while the transducer is switched on. A typical duration 21 of each individual push is 5 to 10 milliseconds, resulting in an intensity of approximately 1100 to 3000 W/cm² which is delivered to the tissue. The acoustic radiation delivered during the push 20 generates a momentum transfer to the tissue which causes the displacement.

Since the time-scale of the tissue relaxation is much slower than that of the ultrasonic wave propagation, the tissue relaxation can be imaged by use of track pulses. The tissue relaxation is tracked or imaged in a second imaging mode by arranging the variable refractive lens in a second configuration, this configuration is discussed in connection with FIG. 3. In the second mode, the transducer generates acoustic radiation for imaging or tracking the displacement of the viscoelastic medium. An example of a track sequence is shown in FIG. 2B. The acoustic radiation 28 is in the form pulses 22, 23, also referred to as track pulses. The tracks pulses are also superpositions of a number of individual pulses, such as a 5 to 10 pulses.

In an embodiment, the two track pulses are emitted subsequent to the push pulse. The track pulses are typically emitted with a separation interval 24 of 15 milliseconds however other separation intervals may be used. The first track pulse 22 is a reference pulse, whereas the second track pulse 23 probes the tissue after relaxation of 15 milliseconds (or other selected time interval). The mechanical properties are derived from the detected time difference of the echo pulses of the two track pulses, as is known in the art. In embodiments, the first and/or second pulses may be placed differently that shown in FIG. 2B. For example, the first pulse may be moved to a position in time 25 just prior to the push pulse, thereby using a reference pulse which is not influenced by the pushing. Additionally more than two pulses may be used. By using a larger number of pulses a more detailed extraction of the mechanical properties can be made.

The tracking may further comprise the step of detecting the backscattered radiation or echo pulses of the emitted track pulses. The echo pulses are detected by the transducer 5 by operating the transducer in a detection mode as is known in the art. During the detection of the echo pulses, the fluid lens configuration remains in the second mode, i.e. in the same configuration as during the emission of the track pulses.

The push-track sequence is repeated with a certain frequency as indicated by the arrow 26.

In an embodiment, the first and second modes of the imaging are interleaved with the ablation process. Thus, the tissue is ablated for a certain period of time, e.g. a few seconds, and the ablation process is temporally stopped while the imaging is conducted. The imaging process may comprise a pre-set number of push-track sequences, such as 2, 5, 10 or even more sequences. After the imaging a next ablation is performed until the treatment is stopped.

FIG. 3 schematically illustrates different configurations of a fluid focus lens assembly. A fluid focus lens comprises two fluids 31, 32 where the interface shape (meniscus) can be controlled by controlling the voltages of the electrodes 33. By properly controlling the voltages at the electrodes, the shape of the meniscus 34 can be controlled as is known in the art. FIGS. 3A to 3C show three configurations: a divergent configuration 30 where the meniscus 34 is concave so that collimated incident radiation 35 is refracted into divergent transmitted radiation 36 (FIG. 3A); a collimated configuration 37 where the meniscus 34 is flat and collimated incident radiation is transmitted through the lens so that the collimation is preserved (FIG. 3B); and a focusing configuration 38 where the meniscus 34 is convex and collimated incident radiation is refracted into focused transmitted radiation (FIG. 3C).

In the first configuration of the fluid focus lens, as used in connection with the first mode, the lens is in a focusing configuration (FIG. 3C), whereas in the second configuration, the fluid focus lens is preferably in the collimation preserving mode (FIG. 3B). However, a slight convex or concave meniscus may be accepted in connection with the tracking.

FIG. 4 schematically illustrates the operation of the fluid focus lens as used in connection with scanned imaging 39. The advantage of applying scanned imaging is that both the tissue which is being displaced directly from the application of the radiation force, as well as the surrounding tissue is monitored. This provides a more complete feedback to the medical doctor during the process. The scanning can be obtained by systematically varying the voltages between the opposite walls to move the collimated beam from side to side as shown in FIGS. 4A to 4C.

By proper variation of the voltages of the electrodes, also the convex meniscus shape of FIG. 3C may be scanned for increasing the pushed area. Alternatively, the distal end of the catheter may be displaced. Displacement of a distal end of a catheter is known to the skilled person, and if desirable, an imaging system in accordance with embodiments of the present invention may be integrated into a catheter with displaceable distal end.

In connection with tracking and imaging the elastic properties of the tissue, variations in the backscattered (echo pulses) acoustic radiation is detected. The variation in the backscattered radiation may origin in scattering and/or absorption of the acoustic radiation in or by the tissue. This interaction of the acoustic radiation with the tissue can be used to derive a number of parameters related to the mechanical properties of the tissue. An example of a parameter which can be extracted is the depth of the tissue, however also other parameters may be extracted.

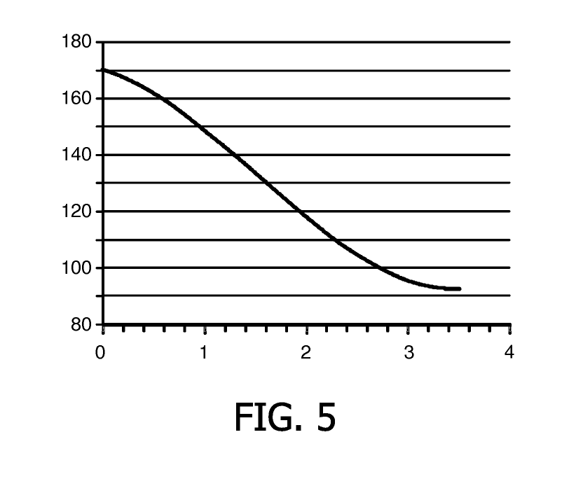

FIG. 5 illustrates an example of a displacement curve showing the displacement in microns (vertical axis) as a function of time in minutes (horizontal axis). The time t=0 is defined as the point of maximum displacement of the tissue (before ablation). Thereafter, the displacement starts to decrease indicating that the tissue is becoming stiffer. The curve is generated by discrete data points spread in time. At each data point (i.e. time interval), a new “push” pulse is sent followed by the “track” pulses.

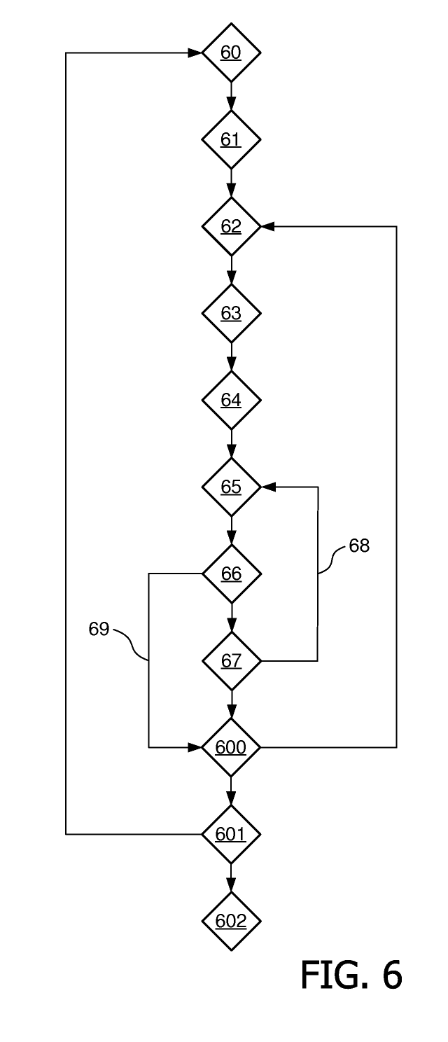

FIG. 6 illustrates a flow chart of the operation of an image system in accordance with embodiments of the present invention. The flow chart describes the situation where the image system is integrated with an ablation modality. The flow chart is described in connection with reference to FIGS. 1 to 4 as well.

The general process comprises the ablation of cardiac tissue interleaved with real-time imaging of the ablated tissue. Cardiac tissue is ablated 60 for a given period of time. The ablation is performed by driving RF actuator 2 of the probe 1. While the ablation is temporally stopped 61, the ultrasound transducer 5 and the fluid lens 4 are operated to alternate between a first mode and a second mode. To generate an imaging pulse, the fluid lens 38 is configured for focusing the acoustic radiation. Thus the focus lens is arranged in a first configuration 62 where the lens configuration is set to generate a convex meniscus and the ultrasonic transducer 5 is operated 63 for a preset amount of time 21 in order to generate a push pulse 20. Next, the variable refractive lens is arranged 64 in a second configuration, where the fluid lens is configured for transmission of collimated radiation. Thus the lens configuration is set 64 to generate a flat meniscus and the ultrasonic transducer 5 is operated 65 to generate two tracking pulses 22, 23. Subsequent to emitting the two tracking pulses, the ultrasonic transducer is configured for detecting 66 the echo pulses of the two tracking pulses 22, 23 in order to extract the time shift between the echo pulses. This time shift is recorded by a controlling unit (not show) connected the transducer for further processing to extract tissue parameters. The general procedure of detecting elastic properties by means of emitting probe pulses and detecting echo pulses is known to the skilled person in the art. If the imaging procedure is such that a scanned image is recorded, the meniscus of the fluid focus lens is inclined 67 in accordance with a predetermined scanning configuration and a new set of tracking pulses is generated 68, and the tracking steps 65-67 is repeated until the scanning has been completed. If the imaging process does not generate a scanned image, the scanning procedure 67, 68 is omitted 69. To improve the quality of the detection, more push pulses may be requested 600 followed by the push-track operation 62-600. The push-track process is repeated until a next ablation sequence is initiated 601 or the imaging is stopped 602.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An imaging system for imaging a viscoelastic medium, the system comprising:
a variable refractive lens (4);
a transducer system (5) for generating acoustic radiation; the acoustic radiation being transmitted through the variable refractive lens;
wherein the imaging system is operated to:
in a first mode
arranging the variable refractive lens in a first configuration (38), and while the variable refractive lens is in the first configuration; operate the transducer system to generate acoustic radiation (27) for displacing the viscoelastic medium; and
in a second mode
arranging the variable refractive lens in a second configuration (37), and while the variable refractive lens is in the second configuration; operate the transducer system to generate acoustic radiation (28) for imaging the displacement of the viscoelastic medium.

2. The imaging system according to claim 1, wherein the variable refractive lens is a fluid lens.

3. The imaging system according to claim 1, wherein the transducer system in the second mode is operated to generate acoustic radiation in the form of two or more imaging pulses (22, 23).

4. The imaging system according to claim 1, wherein the first configuration of the refractive lens is a focusing configuration (38), so that collimated incident acoustic radiation is focused by the refractive lens.

5. The imaging system according to claim 1, wherein the second configuration of the refractive lens is an imaging configuration (37).

6. The imaging system according to claim 1, wherein the refractive lens in the second configuration is arranged for scanned imaging (39).

7. The imaging system according to claim 1, wherein the imaging system is comprised in a catheter-based probe.

8. The imaging system according to claim 1, wherein the imaging system further comprises an interaction modality (2, 3) for modifying the viscoelastic medium.

9. The imaging system according to claim 8, wherein the interaction modality is an ablation unit for ablation of the viscoelastic medium.

10. The imaging system according to claim 8, wherein the interaction modality is operated interleaved with the first and the second modes.

11. An ablation device comprising
an ablation unit for ablation of a viscoelastic medium; and an imaging system according to claim 1 adapted to imagining the ablation of the viscoelastic medium during operation of the ablation device.

12. A computer program product being adapted to enable a computer system comprising at least one computer having data storage means associated therewith to control an imaging system according to claim 1.

13. A method of operating an imaging system, the imaging system comprising
a variable refractive lens (4); and
a transducer system (5) for generating acoustic radiation; the acoustic radiation being transmitted through the variable refractive lens;
wherein the imaging system is operated to:
in a first mode
arranging (62) the variable refractive lens in a first configuration, and while the variable refractive lens is in the first configuration; operate (63) the transducer system to generate acoustic radiation for displacing the viscoelastic medium; and
in a second mode
arranging (64) the variable refractive lens in a second configuration, and while the variable refractive lens is in the second configuration; operate (65) the transducer system to generate acoustic radiation for imaging the displacement of the viscoelastic medium.

14. The method according to claim 13, wherein the imaging system further comprises an interaction modality, and wherein the interaction modality is operated (60) interleaved with the first and the second modes.
